(19) United States
(12) Patent Application Publication
(10) Pub. No.: US 2005/0159850 A1
(43) Pub. Date: Jul. 21, 2005

(54) Shift knob computer operating device

(76) Inventor: Emanuel Melman, Brooklyn, NY (US)

Correspondence Address: JENNIFER MEREDITH;MEREDITH & KEYHANI, 81 LINWOOD AVE, BUFFALO, NY, 14209, US

(21) Appl. No.: 10/759,397

(22) Filed: Jan. 16, 2004

(51) Int. Cl. G06F 17/00

(52) U.S. Cl. 701/1

(57) ABSTRACT

The present invention discloses a computer input device adapted to the environment of an automobile in communication with an in-vehicle computer system. The present invention discloses a easily installed computer-operating device for use in an automobile in conjunction with an in-vehicle computer system that provides the user with an uninhibited, ergonomically comfortable and fully functional mouse like control system. This is accomplished with a base housing unit attached to the gearshift of an automobile with a directional input device and pressure sensitive actuation buttons for the receipt of users fingers.

### BACKGROUND OF THE INVENTION

The present invention generally relates to car mounted electronic input devices. More particularly, the present invention relates to a computer-operating device adapted to the environment of an automobile that performs the functions of a computer mouse for use in conjunction with an in-vehicle computer system such as a navigational system, factory automobile computer system, or in vehicle personal computer.

U.S. Pat. No. 6,593,667 issued to Onodera et al discloses a car mounted input device. The car mounted input device installed in the console of an automobile, allows the user to select the various car mounted electrical devices and control the functions thereof. The '667 patent is a very complex mechanical and electrical system that must be built into the console of an automobile. The manual operating section that the users hand is in communication with can be inclined in a few set directions or rotated, providing limited functionality. The car mounted input device is limited to the control of the electrical devices within the automobile, and has no capability to move a cursor to a specific location on the monitor of the in-vehicle computer system and can not control the myriad of program operations required of an on board computer system.

U.S. patent application US2002/0175894 A1 issued to Grillo discloses a hand-supported mouse for computer input. The hand-supported mouse is comprised of a head portion containing a trackball or other cursor positioning switch and a body portion containing buttons that perform basic mousing functions. A strap secures the mouse to the hand of the user, allowing the user to perform the basic functions of a mouse without having to move his hand to a touch pad or other external mouse attached to a computer. The hand-supported mouse would most definitely be cumbersome for the user when implemented in the environment of an automobile, where one must perform a multitude of tasks which require the unimpeded use of ones hands, such as controlling the steering wheel of the automobile.

US patent application No. US 2002/0118167 issued to MEI et al. discloses a hand-held mobile mouse. The hand-held mobile mouse consists of a housing unit shaped for receipt in the palm of a users hand. A track ball at the top end in communication with the users thumb and a multitude of buttons oriented horizontally along the housing. The hand-held mobile mouse provides the basic function of a computer mouse while providing the convenience of wireless communication with a computer. As in the US2002/0175894 A1 application, a hand held wireless mouse is cumbersome when a user is faced with the task of driving, and its mobile capabilities render it prone to misplacement.

U.S. Pat. No. 6,072,471 issued to Lo discloses an ambidextrous upright computer mouse. The computer mouse as described in the '471 patent is a traditional mouse with the added functionality of being ambidextrous and ergonomically comfortable. The mouse comprises a rolling ball in communication with a surface, which translates the induced movement of the mouse to the corresponding movement of a cursor on the screen of the computer with which the mouse is in communication. The mouse also comprises two actuation buttons, which perform conventional mousing functions. A conventional rolling ball mouse is impractical for use in an automobile where there is virtually no flat surfaces on which the mouse can be properly used.

The use of a mouse in communication with a computer system is well known within the art. Although the prior art performs its specific functions, there is a need within the art for a computer input device adapted to the environment of an automobile in communication with an in-vehicle computer system. The present invention discloses a easily installed computer-operating device for use in an automobile in conjunction with an in-vehicle computer system that provides the user with an uninhibiting, ergonomically comfortable and fully functional mouse like control system.

### SUMMARY OF THE INVENTION

The present invention provides a computer-operating device adapted to the environment of an automobile in communication with an in-vehicle computer system that provides the user with an uninhibiting, ergonomically comfortable and fully functional mouse like control system.

According to one embodiment, a computer-operating device for use in an automobile is disclosed, said device comprising: a housing for the receipt of a users hand mounted atop the gearshift. The computer-operating device further comprises an analog directional input device, at least one pressure sensitive actuation button partially contained within the housing and electronic circuitry within the housing. The electronic circuitry is in electrical communication with the at least one pressure sensitive actuation button and the analog directional input device. The electronic circuitry translates actuation of the at least one actuation button and the position of the analog directional input device into electric signals; a signal transfer means in electrical communication with the computer, and the electronic circuitry; and a power source in communication with the signal transfer means and the electronic circuitry.

According to another embodiment, a computer operating device for use in an automobile is disclosed, the device comprising: an analog directional input device partially contained within the directional input device housing, at least one pressure sensitive actuation button partially contained within the actuation button housing. Electronic circuitry in electrical communication with the at least one pressure sensitive actuation button and the analog directional input device translates actuation of the pressure sensitive actuation button(s) and the position of the analog directional input device into electric signals. A signal transfer means in electrical communication with the computer, and the electronic circuitry; a power source in communication with the signal transfer means, and the electronic circuitry; The computer operating device further comprises a securing means attached to the actuation button housing, and the analog directional input device housing, providing removable communication with the handle of the gearshift of the automobile.

According to another embodiment, a computer-operating device for use in an automobile is disclosed, the device comprising: a housing mounted atop a gearshift of the automobile for the receipt of a users hand; an analog directional input device partially contained within the top of the housing. The analog directional input device is a generally round member having a knob like protrusion inclined in an arbitrary 360 degree planar angle and providing pressure sensitive actuation. The knob of the directional input device is shaped to receive a thumb of the user when the users right hand is in communication with the housing in a grasped vertical stack orientation. The computer-operating device further comprises at least one pressure sensitive actuation button oriented on at least a portion of the left side or front side of the housing, and a lock switch partially contained within the housing with an enabled and disabled state. The pressure sensitive actuation buttons are for the receipt of a portion of the middle or distal phalange of at least one of the users fingers, when the users right hand is in communication with the housing in a grasped vertical stack orientation. Electronic circuitry contained within the housing is in electrical communication with the at least one pressure sensitive actuation button, the lock switch and the analog directional input device for translating actuation of the actuation button switching of the lock switch and the position of the analog directional input device into electric signals. The computer-operating device further comprises a signal transfer means in electrical communication with the computer, the electronic circuitry, and a power source.

According to yet another embodiment, a computer-operating device for use in an automobile is disclosed, the device comprising: a directional input device housing removably attachable to the top of a gearshift handle of the automobile. Partially contained within the directional input device housing is the analog directional input device consisting of a generally round member having a knob like protrusion inclined in an arbitrary 360 degree planar angle also providing pressure sensitive actuation. The knob like protrusion is shaped for the receipt of a thumb of the user when the users right hand is in communication with the gearshift handle in a grasped vertical stack orientation. The computer-operating device further comprises an actuation button housing removably attachable along the vertical axis of at least a portion of the left side or front side of the gearshift handle. Partially contained within the actuation button housing is at least one pressure sensitive actuation button for the receipt of a portion of the middle or distal phalange of at least one of the users fingers, when the users right hand is in communication with the gearshift handle in a grasped vertical stack orientation. A two state lock switch allows for the functions of the computer-operating device to be in an enabled state and disabled state. Electronic circuitry contained within the housing is in electrical communication with the at least one pressure sensitive actuation button, the lock switch and the analog directional input device for translating actuation of the actuation button switching of the lock switch and the position of the analog directional input device into electric signals. The computer-operating device further comprises a signal transfer means in electrical communication with the computer, the electronic circuitry, and a power source. A securing means attached to the actuation button housing, the analog directional input device housing, the signal transfer means and the electronic circuitry providing removable communication with the gearshift handle of the automobile.

These and other features, aspects and advantages of the present invention will become better understood with reference to the following drawings, description and claims.

### BRIEF DESCRIPTION OF THE DRAWINGS

FIG. 1 depicts a human hand;

FIG. 2A is a perspective view of a computer operating device according to an embodiment of the present invention;

FIG. 2B is a perspective view of a computer operating device according to an embodiment of the present invention;

FIG. 2C is a perspective view of a computer operating device according to an embodiment of the present invention;

FIG. 3A is a perspective view of a computer operating device according to an embodiment of the present invention; and

FIG. 3B is a perspective view of a computer operating device according to an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

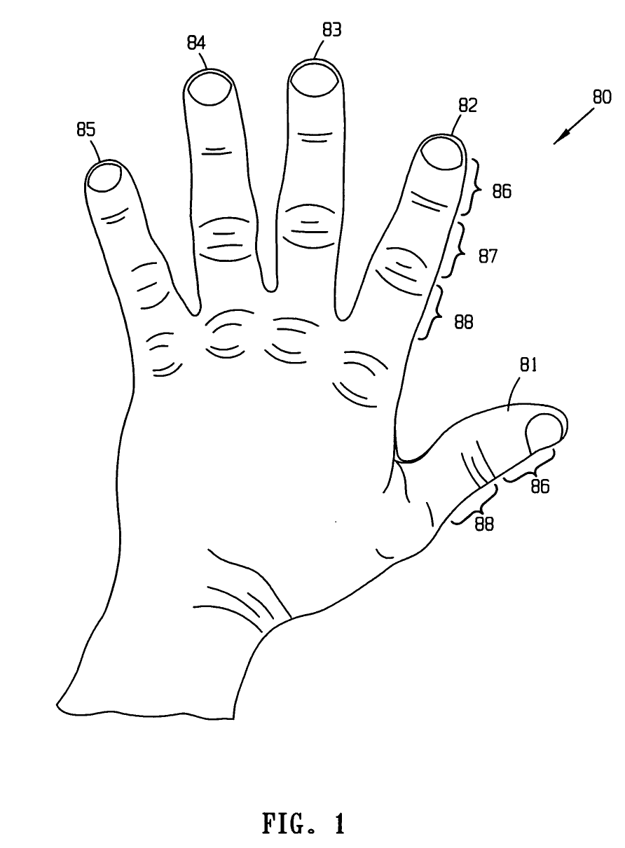

FIG. 1 depicts the right hand 80 having a first digit or thumb 81, second digit 82, third digit 83, fourth digit 84, and fifth digit 85. Each of the second through fifth digits 82, 83, 84, 85 has three phalanges, including a distal phalange 86, a middle phalange 87, and a proximal phalange 88, the thumb 81 has a distal phalange 86 and a proximal phalange 88.

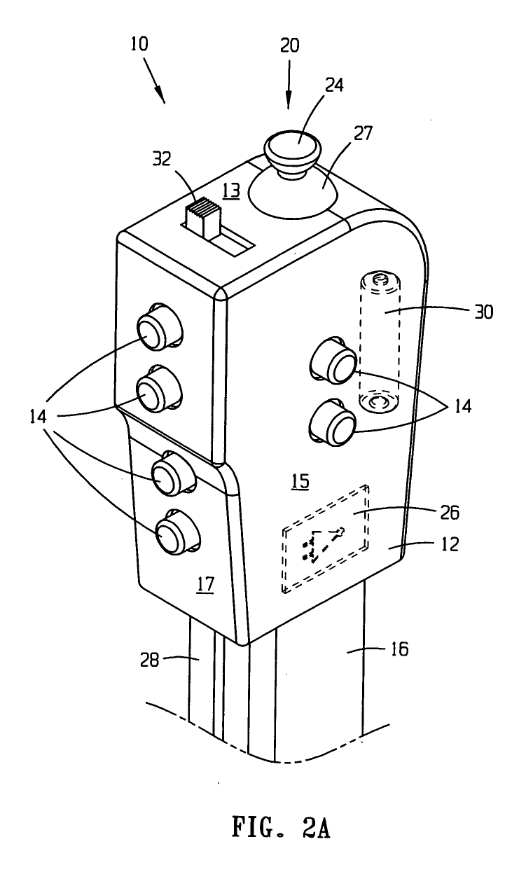

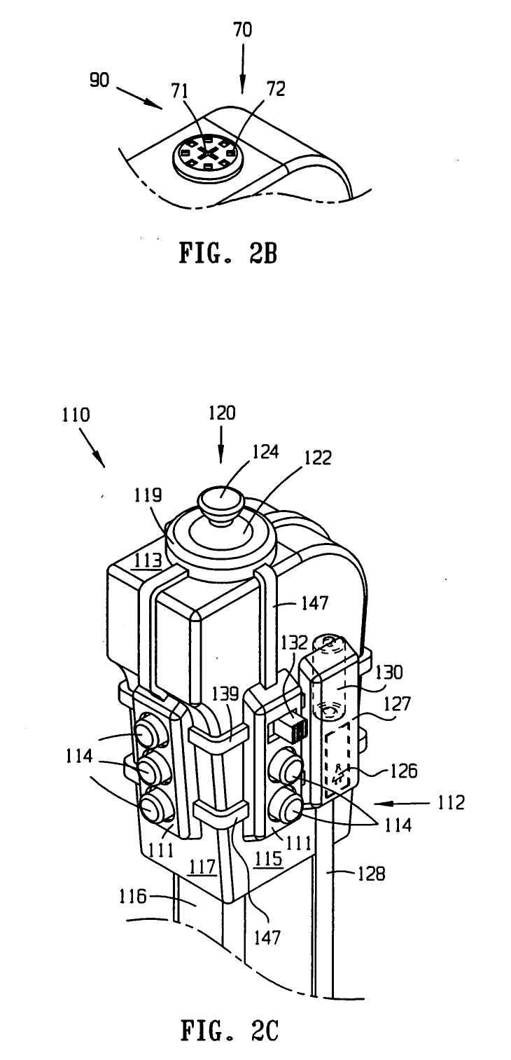

Depicted in FIG. 2A is a computer-operating device 10 for use in an automobile. The computer-operating device 10 is intended for use in conjunction with an in-vehicle computer system. The term in-vehicle computer system is intended to include a navigational system, the factory automobile computer system or in-vehicle personal computer system. The computer-operating device 10 provides a control system for use with the in-vehicle computer system adapted to the environment of an automobile and performs the functions of a computer mouse. The computer-operating device 10 may have a housing 12 for the receipt of a users hand 80 mounted atop the gearshift 16 of an automobile. The computer-operating device 10 is envisioned to replace the existing handle atop the automobile gearshift 16, and is shaped for the receipt of the users right hand 80 when the housing 12 is grasped in a vertical stack orientation. Obviously, it is envisioned that the present invention can be applied to a right hand driven vehicle, wherein the computer-operating device 10 is configured for the receipt of the users left hand when the user grasps the housing in a vertical stack orientation. In many automobiles especially those with a manual gearshift, the gearshift handle is removably attached to the gearshift 16, and easily removed from the gearshift by simply unscrewing the gearshift handle. The computer-operating device 10 may have a threaded insert that can easily be secured onto the gearshift 16 in place of the existing gearshift handle.

The computer-operating device 10 may further comprise an analog directional input device 20 partially contained within the top 13 of the housing 12, for the receipt of the distal phalange 86 of the users thumb 81, when the user grasps the computer-operating device 10 with his right hand 80 in a grasping vertical stack orientation. The shape of the housing 12, and the location of the directional input device 20 provide a comfortable and natural grasp of the computer-operating device 10 similar to the grip one would have on a joystick. The analog directional input device 20 may consist of a generally round member 23 having a knob like protrusion 24 for the receipt of the thumb 81 of the user. The analog directional input device 20 may be a number of different devices such as a X-Y directional pad or trackball. The orientation of the hand 80 in communication with the housing 12 promotes mobility of the thumb 81 in communication with the analog directional input device 20. The knob like protrusion 24 may be inclined in an arbitrary 360-degree planar angle. The direction and the degree of the inclination of the analog directional input device 20 translate to the direction and rate of movement of a cursor on the graphical user interface displayed on the in-vehicle display. The analog directional input device 20 may also act as a pressure sensitive actuation button. When a given amount of pressure is applied to the analog directional input device 20, a sensor communicates an electric signal that commands a function of the in-vehicle computer system. The analog directional input device 20 may include at least one spring therein to automatically right and center the directional input device after it has been inclined in an arbitrary direction.

At least one pressure sensitive actuation button 14 may be oriented on of the left side 15 or front side 17 of the housing 12, for the receipt of a portion of the middle phalange 87 or distal phalange 86 of at least one of the users fingers 82, 83, 84, 85. The depression of the pressure sensitive actuation button(s) 14 communicates an electric signal that when transmitted to the on-board computer translates to a mousing function such as a “left click” or “right click”. The functions of the pressure sensitive actuation button(s) 14 are not limited to the basic existing functions characteristic of computer mice that are well known within the art, but may be a multitude of user defined functions. The pressure sensitive button(s) 14 may also include springs that provide an opposing force needed to overcome to fully depress the pressure sensitive button(s) 14 and initiate the actuation. The springs in communication with the pressure sensitive button(s) 14 also return the pressure sensitive button(s) to their original position fully extended out of the housing 12.

The computer-operating device 10 is further comprised of electronic circuitry 26 within the housing 12, in electrical communication with the pressure sensitive actuation button(s) 14 and the analog directional input device 20. Sensor(s) in communication with the analog directional input device 20 paired with the electronic circuitry 26 translate the position of the analog directional input device 20 into the electric control signals that are transmitted to the in-vehicle computer dictating the position of the cursor displayed on the in-vehicle display system. Sensor(s) in communication with the pressure sensitive actuation button(s) 14 and the electronic circuitry 26 converts the mechanical act of depressing the pressure sensitive actuation button(s) 14 to an electrical control signal that performs a computer function when transmitted to the in-vehicle computer.

A signal transfer means 28 interfaces the electronic circuitry 26 and the in-vehicle computer system. The signal transfer means 28 may be a USB, PS/2, FireWire, or serial interface. The signal transfer means 28 may also be a wireless interface such as infrared or radio frequency transmission. Signals may be transferred uni-directionally from the electronic circuitry 26 to the in-vehicle computer system or bi-directionally from the electronic circuitry 26 to the in-vehicle computer system and vice versa.

A power source 30 is in communication with the electronic circuitry. The power source 30 may be a disposable or a rechargeable battery cell contained within the housing 12. The power source 30 may also be an external power source, for example the power source of the in-vehicle computer system with which the computer-operating device 10 is in communication. In the case of the power source 30 being external to the computer-operating device 10 such as the in-vehicle computer system, the signal transfer means 28 may act as the conduit through which the computer-operating device 10 receives power from the in-vehicle computer system.

The computer-operating device 10 may further comprise a lock switch 32 partially contained within the housing 12. The lock switch 32 consists of two states. One state of the lock switch 32 is the enable state. In the enable state, the at least one actuation button 14 and the directional input device 20 are active. When the lock switch 32 is in the disabled state, the at least one pressure sensitive actuation button 14 and the directional input device 20 are disabled, as to prevent inadvertent actuation or directional inputs to the computer.

Depicted in FIG. 2B is the computer operating device 90 comprising consisting of an X-Y pad directional input device 71. The X-Y pad directional input 71 device may comprise a X-Y pad 71 for the receipt of a users thumb 81. The X-Y pad directional input device 70 further comprises a multitude of sensors 72, in communication with the X-Y pad and the electronic circuitry. When a given amount of pressure is applied to the X-Y pad sensor(s) communicates an electric signal to the in-vehicle computer system which translates to the direction of movement of a cursor on the in-vehicle computer system display. The X-Y directional pad input device 70 may include at least one spring therein to automatically level and center the directional input device after it has been inclined in an arbitrary direction.

Depicted in FIG. 2C is a computer-operating device 110 for use in an automobile that is removably attachable to the existing gearshift handle 112 of the automobile. The computer-operating device 110 is intended for use in conjunction with an in-vehicle computer system. The term in-vehicle computer system is intended to include a navigational system, the factory automobile computer system or in-vehicle personal computer system. The computer-operating device 110 provides a control system for use with the in-vehicle computer system adapted to the environment of an automobile and performs the functions of a computer mouse. The computer-operating device 110 is envisioned to be removably attachable to the existing automobile gearshift handle 112, and is positioned and shaped for the receipt of the users right hand 80 when the gearshift handle 112 is grasped in a vertical stack orientation. Obviously, it is envisioned that the present invention can be applied to a right hand driven vehicle, wherein the computer-operating device 110 is configured for the receipt of the users left hand when the user grasps the gearshift handle 112 in a vertical stack orientation.

The computer-operating device 110 may further comprise an analog directional input device 120 partially contained within the directional input device housing 119 removably attachable to the top 113 of the gearshift handle 112, for the receipt of the distal phalange 86 of the users thumb 81, when the user grasps the computer-operating device 110 with the right hand 80 in a grasping vertical stack orientation. The shape of the gearshift handle 112 and directional input device housing 119, and the location of the directional input device 120 provide a comfortable and natural grasp of the gearshift handle 112 and computer-operating device 110 similar to the grip one would have on a joystick. The analog directional input device 120 may consist of a generally round member 122 having a knob like protrusion 124 for the receipt of the thumb 81 of the user. The analog directional input device 120 may be a number of different devices such as a trackball or X-Y directional pad. The orientation of the hand 80 in communication with the gearshift handle 112 promotes mobility of the thumb 81 in communication with the analog directional input device 120. The knob like protrusion 124 may be inclined in an arbitrary 360-degree planar angle. The direction and the degree of the inclination of the analog directional input device 120 translate to the direction and rate of movement of a cursor on the graphical user interface displayed on the in-vehicle display. The analog directional input device 120 may also act as a pressure sensitive actuation button. When a given amount of pressure is applied to the analog directional input device 120, a sensor communicates an electric signal that commands a function of the in-vehicle computer system. The analog directional input device 120 may include at least one spring therein to automatically right and center the directional input device 120 after it has been inclined in an arbitrary direction.

At least one pressure sensitive actuation button 114 partially contained within an actuation button housing 111 may be removably attachable on the left side 115 or front side 117 of the gearshift handle 112, for the receipt of a portion of the middle phalange 87 or distal phalange 86 of at least one of the users fingers 82, 83, 84, 85. The depression of the pressure sensitive actuation button(s) 114 communicates an electric signal that when transmitted to the in-vehicle computer translates to a mousing function such as a “left click” or “right click”. The functions of the pressure sensitive actuation button(s) 114 are not limited to the basic existing functions characteristic of computer mice that are well known within the art, but may be a multitude of user defined functions. The pressure sensitive actuation button(s) 114 may also include spring(s) that provide an opposing force needed to overcome to fully depress the pressure sensitive button(s) 114 and initiate the actuation. The spring(s) in communication with the pressure sensitive button(s) 114 also return the pressure sensitive button(s) 114 to their original position fully extended out of the actuation button housing 111.

The computer-operating device 110 is further comprised of electronic circuitry 126, in electrical communication with the pressure sensitive actuation button(s) 114 and the analog directional input device 120. The electronic circuitry 126 may be contained in the electronic circuitry housing 127 the actuation button housing 111 or the directional input device housing 119. Sensor(s) in communication with the analog directional input device 120 paired with the electronic circuitry 126 translate the position of the analog directional input device 120 into the electric control signals that are transmitted to the in-vehicle computer dictating the position of the cursor displayed on the in-vehicle display system. Sensor(s) in communication with the pressure sensitive actuation button(s) and the electronic circuitry convert the mechanical act of depressing the pressure sensitive actuation button(s) 114 to an electrical control signal that performs a computer function when transmitted to the in-vehicle computer.

A signal transfer means 128 interfaces the electronic circuitry 126 and the in-vehicle computer system. The signal transfer means 128 may be a USB, PS/2, FireWire, or serial interface. The signal transfer means 128 may also be a wireless interface such as infrared or radio frequency transmission. Signals may be transferred uni-directionally from the electronic circuitry 126 to the in-vehicle computer system or bi-directionally from the electronic circuitry 126 to the in-vehicle computer system and vice versa.

A power source 130 is in communication with the electronic circuitry. The power source 130 may be a disposable or a rechargeable battery cell contained within either the electronic circuitry housing 127, directional input device housing 119 or the actuation button housing 111. The power source 130 may also be an external power source, for example the power source of the in-vehicle computer system with which the computer-operating device 110 is in communication. In the case of the power source 130 being external to the computer-operating device 110 such as the in-vehicle computer system, the signal transfer means 128 may act as the conduit through which the computer-operating device 110 receives power from the in-vehicle computer system.

The computer-operating device may further comprise a lock switch 132 partially contained within the directional input device housing 119 or the actuation button housing 111. The lock switch 132 consists of two states an enable state and a disable state. In the enable state, the at least one actuation buttons 114 and the directional input device 120 are active. When the lock switch 132 is in the disabled state, the at least one pressure sensitive actuation button 114 and the directional input device 120 are disabled, as to prevent inadvertent actuation or directional inputs to the computer.

A conducting cable 147 electrically connects the actuation button(s) 114, the analog directional input device 120 and the electronic circuitry 126. A securing means 139 attached to the actuation button housing 114, the analog directional input device housing 119 and the electronic circuitry housing 127, provides removable communication with the gearshift handle 112 of the automobile. The securing means 139 may be a stretchable fabric in which all components of the computer-operating device 110 are a collective unit that may be placed over and around the gearshift handle 112 of an automobile. The components of the computer-operating device 110 may be removably attached to the gearshift handle using an adhesive.

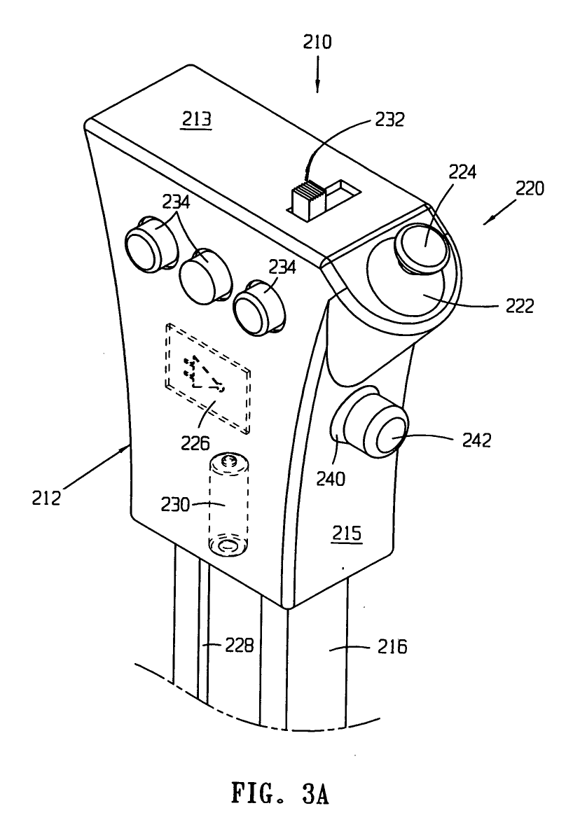

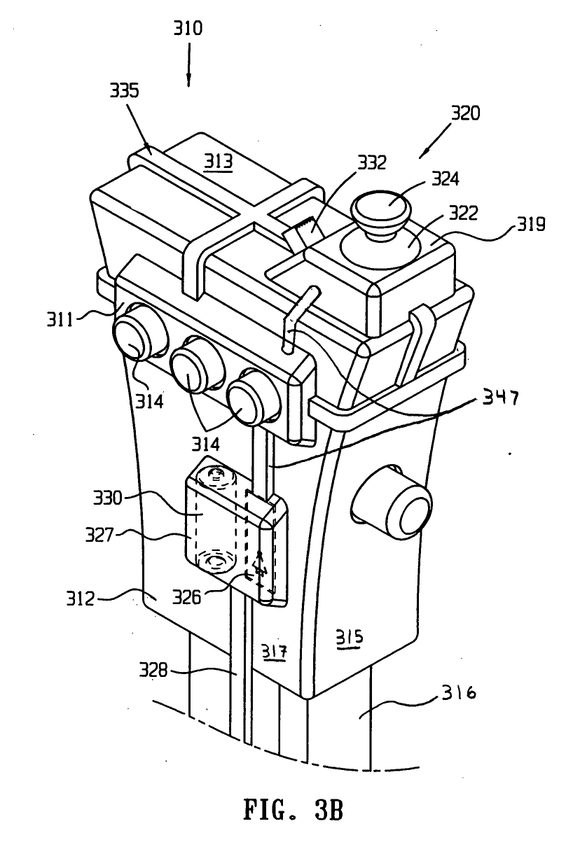

Depicted in FIG. 3A is a computer-operating device 210 for use in an automobile. The computer-operating device 210 is intended for use in conjunction with an in-vehicle computer system. The term in-vehicle computer system is intended to include a navigational system, the factory automobile computer system or in-vehicle personal computer system. The computer-operating device 210 provides a control system for use with the in-vehicle computer system adapted to the environment of an automobile and performs the functions of a computer mouse. The computer-operating device 210 may have a housing 212 for the receipt of a users hand 80 mounted atop the gearshift 216 of an automobile. The computer-operating device 210 is envisioned to replace the existing handle atop the automobile gearshift 216, and is shaped for the receipt of the users right hand 80 when the housing 212 is grasped in a horizontal, palm down orientation. Obviously, it is envisioned that the present invention can be applied to a right hand driven vehicle, wherein the computer-operating device 210 is configured for the receipt of the users left hand when the user grasps the housing in a horizontal palm down orientation.

The computer-operating device 210 may further comprise an analog directional input device 220 partially contained within the left side 215 of the housing 212, for the receipt of the distal phalange 86 of the users thumb 81, when the user grasps the computer-operating device 210 with his right hand 80 in a grasping vertical stack orientation. The shape of the housing 212, and the location of the directional input device 220 provide a comfortable and natural grasp of the computer-operating device 210. The analog directional input device 220 may consist of a generally round member 222 having a knob like protrusion 224 for the receipt of the thumb 81 of the user. The analog directional input device 220 may be a number of different devices such as a trackball or X-Y directional pad. The orientation of the hand 80 in communication with the housing 212 promotes mobility of the thumb 81 in communication with the analog directional input device 220. The knob like protrusion 224 may be inclined in an arbitrary 360-degree planar angle. The direction and the degree of the inclination of the analog directional input device 220 translate to the direction and rate of movement of a cursor on the in-vehicle computer display. The analog directional input device 220 may also act as a pressure sensitive actuation button. When a given amount of pressure is applied to the analog directional input device 220, a sensor communicates an electric signal that commands a function of the in-vehicle computer system. The analog directional input device 220 may include at least one spring therein to automatically right and center the directional input device after it has been inclined in an arbitrary direction.

At least one pressure sensitive actuation button 234 may be oriented on of the front side 217 of the housing 212, for the receipt of a portion of the middle phalange 87 or distal phalange 86 of at least one of the users fingers 82, 83, 84, 85. The depression of the pressure sensitive actuation button(s) 214 communicates an electric signal that when transmitted to the in-vehicle computer translates to a mousing function such as a “left click” or “right click”. The functions of the pressure sensitive actuation button(s) 234 are not limited to the basic existing functions characteristic of computer mice that are well known within the art, but may be a multitude of user defined functions. The pressure sensitive button(s) 234 may also include spring(s) that provide an opposing force needed to overcome to fully depress the pressure sensitive button(s) 234 and initiate the actuation. The springs in communication with the pressure sensitive button(s) 214 also return the pressure sensitive button(s) to their original position fully extended out of the housing 212.

The computer-operating device 210 is further comprised of electronic circuitry 226 within the housing 212, in electrical communication with the pressure sensitive actuation button(s) 214 and the analog directional input device 220. Sensor(s) in communication with the analog directional input device 220 paired with the electronic circuitry 226 translate the position of the analog directional input device 220 into the electric control signals that are transmitted to the in-vehicle computer dictating the position of the cursor displayed on the in-vehicle display system. Sensor(s) in communication with the pressure sensitive actuation button(s) 214 and the electronic circuitry converts the mechanical act of depressing the pressure sensitive actuation button(s) 214 to an electrical control signal that performs a computer function when transmitted to the in-vehicle computer.

A signal transfer means 228 interfaces the electronic circuitry 226 and the in-vehicle computer system. The signal transfer means 228 may be a USB, PS/2, FireWire, or serial interface. The signal transfer means 228 may also be a wireless interface such as infrared or radio frequency transmission. Signals may be transferred uni-directionally from the electronic circuitry 226 to the in-vehicle computer system or bi-directionally from the electronic circuitry 226 to the in-vehicle computer system and vice versa.

A power source 230 is in communication with the electronic circuitry. The power source 230 may be a disposable or a rechargeable battery cell contained within the housing 212. The power source 230 may also be an external power source, for example the power source of the in-vehicle computer system with which the computer-operating device is in communication. In the case of the power source 230 being external to the computer-operating device 210 such as the in-vehicle computer system, the signal transfer means 228 may act as the conduit through which the computer-operating device 210 receives power from the in-vehicle computer system.

The computer-operating device may further comprise a lock switch 232 partially contained within the housing 212. The lock switch 232 consists of two states. One state of the lock switch 232 is the enable state. In the enable state, the at least one actuation button 214 and the directional input device 220 are active. When the lock switch 232 is in the disabled state, the at least one pressure sensitive actuation button 214 and the directional input device 220 are disabled, as to prevent inadvertent actuation or directional inputs to the computer.

On many automatic transmission automobiles, a locking mechanism 242 exists within the gearshift 216 that must be released in order for the driver to engage the vehicle in a gear other than park. The computer-operating device 210 may further comprise an opening 240 in the housing 212 for the receipt of a gearshift locking mechanism 242, providing a computer-operating device 210 that may also perform the function of unlocking the gearshift 216.

Depicted in FIG. 3B is a computer-operating device 310 for use in an automobile that is removably attachable to the existing gearshift handle 312 of the automobile. The computer-operating device 310 is intended for use in conjunction with an in-vehicle computer system. The term in-vehicle computer system is intended to include a navigational system, the factory automobile computer system or in-vehicle personal computer system. The computer-operating device 310 provides a control system for use with the in-vehicle computer system adapted to the environment of an automobile and performs the functions of a computer mouse. The existing gearshift handle 312 in conjunction with the removably attachable computer-operating device 310 is shaped for the receipt of a users hand 80 grasping the gearshift 316 of an automobile. The computer-operating device 310 is envisioned to be removably attachable to the existing automobile gearshift handle 312, and is positioned and shaped for the receipt of the users right hand 80 when the gearshift handle 312 is grasped in a horizontal palm down orientation. Obviously, it is envisioned that the present invention can be applied to a right hand driven vehicle, wherein the computer-operating device 310 is configured for the receipt of the users left hand when the user grasps the housing in a horizontal palm down orientation.

The computer-operating device 310 may further comprise an analog directional input device 320 partially contained within the directional input device housing 319 removably attachable to the left side 315 of the gearshift handle 312, for the receipt of the distal phalange 86 of the users thumb 81, when the user grasps the computer-operating device 310 with the right hand 80 in a grasping vertical stack orientation. The shape of the gearshift handle 312 and directional input device housing 319, and the location of the directional input device 320 provide a comfortable and natural grasp of the gearshift handle 312 and computer-operating device 310. The analog directional input device 320 may consist of a generally round member 322 having a knob like protrusion 324 for the receipt of the thumb 81 of the user. The analog directional input device 320 may be a number of different devices such as a trackball or X-Y directional pad. The orientation of the hand 80 in communication with the gearshift handle 312 promotes mobility of the thumb 81 in communication with the analog directional input device 320. The knob like protrusion 324 may be inclined in an arbitrary 360-degree planar angle. The direction and the degree of the inclination of the analog directional input device 320 translate to the direction and rate of movement of a cursor on the in-vehicle computer display. The analog directional input device 320 may also act as a pressure sensitive actuation button. When a given amount of pressure is applied to the analog directional input device 320, a sensor communicates an electric signal that commands a function of the in-vehicle computer system. The analog directional input device 320 may include at least one spring therein to automatically right and center the directional input device 320 after it has been inclined in an arbitrary direction.

At least one pressure sensitive actuation button 314 partially contained within an actuation button housing 311 may be removably attachable on the front side 317 of the gearshift handle 312, for the receipt of a portion of the middle phalange 87 or distal phalange 86 of at least one of the users fingers 82, 83, 84, 85. The depression of the pressure sensitive actuation button(s) 314 communicates an electric signal that when transmitted to the in-vehicle computer translates to a mousing function such as a “left click” or “right click”. The functions of the pressure sensitive actuation button(s) 314 are not limited to the basic existing functions characteristic of computer mice that are well known within the art, but may be a multitude of user defined functions. The pressure sensitive actuation button(s) 314 may also include spring(s) that provide an opposing force needed to overcome to fully depress the pressure sensitive button(s) 314 and initiate the actuation. Spring(s) in communication with the pressure sensitive button(s) 314 may also return the pressure sensitive button(s) 314 to their original position fully extended out of the actuation button housing 311.

The computer-operating device 310 is further comprised of electronic circuitry 326, in electrical communication with the pressure sensitive actuation button(s) 314 and the analog directional input device 320. The electronic circuitry 326 may be contained in the electronic circuitry housing 327 the actuation button housing 311 or the directional input device housing 319. Sensor(s) in communication with the analog directional input device 320 paired with the electronic circuitry 326 translate the position of the analog directional input device 320 into the electric control signals that are transmitted to the in-vehicle computer dictating the position of the cursor displayed on the in-vehicle display system. Sensor(s) in communication with the pressure sensitive actuation button(s) 314 and the electronic circuitry converts the mechanical act of depressing the pressure sensitive actuation button(s) 314 to an electrical control signal that performs a computer function when transmitted to the in-vehicle computer.

A signal transfer means 328 interfaces the electronic circuitry 326 and the in-vehicle computer system. The signal transfer means 328 may be a USB, PS/2, FireWire, or serial interface. The signal transfer means 328 may also be a wireless interface such as infrared or radio frequency transmission. Signals may be transferred uni-directionally from the electronic circuitry 326 to the in-vehicle computer system or bi-directionally from the electronic circuitry 326 to the in-vehicle computer system and vice versa.

A power source 330 is in communication with the electronic circuitry. The power source 330 may be a disposable or a rechargeable battery cell contained within either the electronic circuitry housing 327 directional input device housing 319 or the actuation button housing 311. The power source 330 may also be an external power source, for example the power source of the in-vehicle computer system with which the computer-operating device 310 is in communication. In the case of the power source 330 being external to the computer-operating device 310 such as the in-vehicle computer system, the signal transfer means 328 may act as the conduit through which the computer-operating device 310 receives power from the in-vehicle computer system.

The computer-operating device may further comprise a lock switch 332 partially contained within the directional input device housing 319 or the actuation button housing 311. The lock switch 332 consists of two states, an enable state and a disable state. In the enable state, the at least one actuation button 314 and the directional input device 320 are active. When the lock switch 332 is in the disabled state, the at least one pressure sensitive actuation button 314 and the directional input device 320 are disabled, as to prevent inadvertent actuation or directional inputs to the computer.

A conducting cable 347 electrically connects the actuation button(s) 314, the analog directional input device 320 and the electronic circuitry 326. A securing means 339 attached to the actuation button housing 314, the analog directional input device housing 319 and the electronic circuitry housing 327, provides removable communication with the handle of the gearshift of the automobile. The securing means 335 may be a stretchable fabric in which all components of the computer-operating device 310 are a collective unit that may be placed over and around the gearshift handle of an automobile. The components of the computer-operating device 310 may also be removably attached to the gearshift handle using an adhesive.

1. A computer operating device for use in an automobile, said device comprising:
a housing for the receipt of a users hand mounted atop the gearshift;
an analog directional input device partially contained within said housing;
at least one pressure sensitive actuation button partially contained within said housing;
electronic circuitry within said housing, in electrical communication with said at least one pressure sensitive actuation button and said analog directional input device, translating actuation of said actuation button and the position of said analog directional input device into electric signals;
a signal transfer means in electrical communication with said computer, and said electronic circuitry; and
a power source in communication with said signal transfer means and said electronic circuitry.

2. A computer operating device as in claim 1, further comprising an opening in said housing for receipt of a locking mechanism of said gearshift.

3. A computer operating device as in claim 1, wherein said analog directional input device is partially contained within the top of said housing, for the receipt of said users thumb when said users right hand is in communication with said housing in a grasped vertical stack orientation.

4. A computer operating device as in claim 1, wherein said analog directional input device is partially contained within the left side of said housing for the receipt of the thumb of said user when said users right hand is in communication with said housing in a grasped horizontal palm down orientation.

5. A computer operating device as in claim 1, wherein said analog directional input device is a generally round member having a knob like protrusion inclined in an arbitrary 360 degree planar angle for the receipt of a finger of said user.

6. A computer operating device as in claim 1, wherein said analog directional input device is a generally round member having a knob like protrusion inclined in an arbitrary 360 degree planar angle, and is a pressure sensitive actuation button for the receipt of a finger of said user.

7. A computer operating device as in claim 1, wherein said analog directional input device consists of a multitude of actuators depressible in an arbitrary 360 degree planar angle with an X-Y directional pad for the receipt of a finger of said user.

8. A computer operating device as in claim 1, wherein said signal transfer means is selected from the group, radio, infrared, USB, PS/2, firewire, serial interface.

9. A computer operating device as in claim 1, wherein said at least one pressure sensitive actuation button is oriented on at least a portion of the left side or front side of said housing for the receipt of a portion of the middle or distal phalange of at least one of said users fingers when said users right hand is in communication with said housing in a grasped vertical stack orientation.

10. A computer operating device as in claim 1, wherein said at least one pressure sensitive actuation button is oriented on least a portion of the front side of said housing for the receipt of a portion of the middle or distal phalange of at least one of said users fingers, when said users right hand is in communication with said housing in a grasped horizontal palm down orientation.

11. A computer operating device as in claim 1, wherein a lock switch is partially contained within said housing, said lock switch having an enabled and disabled state.

12. A computer operating device as in claim 1, wherein said power source is selected from the group, battery power source, computer power source.

13. An computer operating device for use in an automobile, said device comprising:
a directional input device housing;
an analog directional input device partially contained within said directional input device housing;
an actuation button housing;
at least one pressure sensitive actuation button partially contained within said actuation button housing;
electronic circuitry in electrical communication with said at least one pressure sensitive actuation button and said analog directional input device, translating actuation of said actuation button and the position of said analog directional input device into electric signals;
a signal transfer means in electrical communication with said computer, and said electronic circuitry;
a power source in communication with said signal transfer means, and said electronic circuitry; and
a securing means attached to said actuation button housing, said analog directional input device housing, providing removable communication with the handle of said gearshift of said automobile.

14. A computer operating device as in claim 13, wherein said directional input device housing is removably attachable to the top of said gearshift handle for the receipt of said users thumb when said users right hand is in communication with said gearshift in a grasped vertical stack orientation.

15. A computer operating device as in claim 13, wherein said directional input device housing is removably attachable to the left side of said gearshift handle for the receipt of said users thumb when said users right hand is in communication with said gearshift in a grasped horizontal palm down orientation.

16. A computer operating device as in claim 13, wherein said analog directional input device is a generally round member having a knob like protrusion inclined in an arbitrary 360 degree planar angle for the receipt of a finger of said user.

17. A computer operating device as in claim 13, wherein said analog directional input device is a generally round member having a knob like protrusion inclined in an arbitrary 360 degree planar angle and is a pressure sensitive actuation button for the receipt of a finger of said user.

18. A computer operating device as in claim 13, wherein said analog directional input device is comprised of a multitude of actuators depressible in an arbitrary 360 degree planar angle with an X-Y directional pad for the receipt of a finger of said user.

19. A computer operating device as in claim 13, wherein said signal transfer means is selected from the group, radio, infrared, USB, PS/2, firewire, serial interface.

20. A computer operating device as in claim 13, wherein said actuation button housing is removably attachable on a portion of the left side or front side of said gearshift handle for the receipt of a portion of the middle or distal phalange of at least one of said users fingers when said users right hand is in communication with said gearshift handle in a grasped vertical stack orientation.

21. A computer operating device as in claim 13, wherein said actuation button housing is removably attachable on at least a portion of the front side of said gearshift handle for the receipt of a portion of the middle or distal phalange of at least one of said users fingers when said users right hand is in communication with said gearshift handle in a grasped horizontal, palm down orientation.

22. A computer operating device as in claim 13, wherein a lock switch is partially contained within said directional input device housing, said lock switch having an enabled and disabled state.

23. A computer operating device as in claim 13, wherein a lock switch is partially contained within said actuation button housing, said lock switch having an enabled and disabled state.

24. A computer operating device as in claim 13, wherein said power source is selected from the group, battery power source, computer power source.

25. A computer operating device for use in an automobile, said device comprising:
a housing mounted atop a gearshift of said automobile for the receipt of a users hand;
an analog directional input device partially contained within the top of said housing, wherein said analog directional input device is a generally round member having a knob like protrusion inclined in an arbitrary 360 degree planar angle providing pressure sensitive actuation, wherein said knob is shaped to receive a thumb of said user when said users right hand is in communication with said housing in a grasped vertical stack orientation.
at least one pressure sensitive actuation button on at least a portion of the left side or front side of said housing for the receipt of a portion of the middle or distal phalange of at least one of said users fingers, when said users right hand is in communication with said housing in a grasped vertical stack orientation;
electronic circuitry within said housing, said electronic circuitry being in electrical communication with said at least one pressure sensitive actuation button and said analog directional input device for translating actuation of said actuation button and the position of said analog directional input device into electric signals;
a signal transfer means in electrical communication with said computer, and said electronic circuitry;
a lock switch partially contained within said housing, said lock switch having an enabled and disabled state; and
a power source in communication with said signal transfer means and said electronic circuitry.

26. A computer operating device as in claim 25, wherein said signal transfer means is selected from the group, radio, infrared, USB, PS/2, firewire, serial Interface.

27. A computer operating device as in claim 25, wherein said power source is selected from the group, battery power source, computer power source.

28. A computer operating device for use in an automobile, said device comprising:
a directional input device housing removably attachable to the top of a gearshift handle of said automobile;
an analog directional input device partially contained within said directional input device housing consisting of a generally round member having a knob like protrusion inclined in an arbitrary 360 degree planar angle providing pressure sensitive actuation, wherein said knob is shaped for the receipt of a thumb of said user when said users right hand is in communication with said gearshift handle in a grasped vertical stack orientation.
an actuation button housing removably attachable to at least a portion of the left side or front side of said gearshift handle
at least one pressure sensitive actuation button partially contained within said actuation button housing, for the receipt of a portion of the middle or distal phalange of at least one of said users fingers, when said users right hand is in communication with said gearshift handle in a grasped vertical stack orientation;
electronic circuitry in electrical communication with said at least one pressure sensitive actuation button and said analog directional input device, translating actuation of said actuation button and the position of said analog directional input device into electric signals;
a signal transfer means in electrical communication with said computer, and said electronic circuitry;
a lock switch partially contained within said actuation button housing, said lock switch having an enabled and disabled state;
a power source in communication with said signal transfer means and said electronic circuitry; and
a securing means attached to said actuation button housing, said analog directional input device housing, said signal transfer means and said electronic circuitry providing removable communication with said gearshift handle of said automobile.

29. A computer operating device as in claim 28, wherein said signal transfer means is selected from the group, radio, infrared, USB, PS/2, firewire, serial Interface.

30. A computer operating device as in claim 28, wherein said power source is selected from the group, battery power source, computer power source.
